(19) United States
(12) Patent Application Publication
(10) Pub. No.: US 2003/0103618 A1
(43) Pub. Date: Jun. 5, 2003

(54) Voice browsing while waiting in a hold queue

(75) Inventors: Michael Wayne Brown, Georgetown, TX (US); David R. Cheng, Wilmington, DE (US); Wing-Ying Stephanie Leung, Ann Arbor, MI (US); Folu Okunseinde, Oakhurst, NJ (US); Michael A. Paolini, Austin, TX (US); Seema Sheth-Voss, Cambridge, MA (US); Scott Lee Winters, Austin, TX (US)

Correspondence Address: Cynthia S. Byrd, International Business Machines Corporation, Intellectual Property Law Department, 11400 Burnet Road, Austin, TX, 78758, US

(73) Assignee: INTERNATIONAL BUSINESS MACHINES CORPORATION, ARMONK, NY (US)

(21) Appl. No.: 10/006,004

(22) Filed: Dec. 3, 2001

(51) Int. Cl. H04M 3/00; H04M 5/00

(52) U.S. Cl. 379/265.09

(57) ABSTRACT

A method, system, and program for voice browsing while waiting in a hold queue are provided. Callers waiting in a hold queue are prompted to select a help subject for a call. A specified menu of browsable help information is output to the caller according to the help subject selected by the caller. Then, a web script is translated into audio output to the caller for a the caller's selection from the specified menu of browsable help information.

### CROSS-REFERENCE TO RELATED APPLICATIONS

The present application is related to the following copending applications, incorporated herein by reference:

(1) U.S. patent application Ser. No. ______ (Attorney Docket No. AUS920010944US1);

(2) U.S. patent application Ser. No. ______ (Attorney Docket No. AUS920010945US1);

(3) U.S. patent application Ser. No. ______ (Attorney Docket No. AUS920010947US1); and

(4) U.S. patent application Ser. No. ______ (Attorney Docket No. AUS920010948US1).

### BACKGROUND OF THE INVENTION

1. Technical Field

The present invention relates in general to telecommunications and, in particular, to call hold centers.

Still more particularly, the present invention relates to voice browsing while on hold in a call queue.

2. Description of the Related Art

Many companies provide telephone-based access to help staff, sales personnel, representatives, and automated menus via a call center. Where high telephone call traffic is typical in telephone access to a company's representatives, a PBX system receives the call and distributes the call to an automatic call distributor (ACD), thus incorporating a hold function in the call center. ACDs are often employed to provide an even and systematic distribution of incoming calls to multiple representatives. In particular, ACDs typically provide incoming calls with a direct connection to an available representative until all representatives are busy. Then, calling parties are placed in a call queue, and selectively connected to a representative once a representative comes available.

Call queues may cause frustration and ill will of consumers towards a company, particularly where excessively long waits, full queues and accidental disconnects are encountered. One way to alleviate some of the frustration associated with call queues is by allowing the caller to select from a menu of multiple services while waiting. Such services may include music, news, weather, release of a the line to call a third-party, transfer of the call to a chat room of other callers on hold, competitions, and other activities in which callers may participate while on hold. While participating in the services, the caller may receive periodic updates as to a position in the queue and an estimated wait time remaining.

In order to provide the caller with a menu of services, interactive voice response units (IVRU) are often utilized. For example, a caller placed in a queue of a call center may be enabled to access multiple entertainment options while on hold. An IVRU provides the caller with a menu of available entertainment options accessible while on hold. While IVRU systems provide a method for prompting a caller to select from a menu and then automating a transcript of information selected by the caller, IVRU systems are costly and are limited only to output of transcripted information. For example, a news transcript is output as a news service. However, the news transcript may not cover a particular news item of interest to the caller.

In view of the foregoing, it would be advantageous to provide a method, system, and program for allowing a caller to browse web pages while on hold in a call queue. In addition, it would be advantageous to provide a method, system, and program for allowing a caller to browse a selection of web pages that are specified for the caller according to a caller profile while the caller is on hold in a call queue.

### SUMMARY OF THE INVENTION

In view of the foregoing, it is therefore an object of the present invention to provide an improved telecommunications system.

It is another object of the present invention to provide a method, system and program for improved call hold queues.

It is yet another object of the present invention to provide a method, system and program for voice browsing while on hold in a call queue.

According to one aspect of the present invention, callers waiting in a hold queue are prompted to select a help subject for a call. A specified menu of browsable help information is output to the caller according to the help subject selected by the caller. Then, a web script is translated into audio output to the caller for the caller's selection from the specified menu of browsable help information.

All objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts a block diagram of a network call or contact center system in which the present invention may be implemented;

FIG. 2 illustrates a block diagram of a voice browsing system in accordance with the method, system, and program of the present invention;

FIG. 3 depicts a block diagram of an on hold system in accordance with the method, system, and program of the present invention;

FIG. 4 illustrates an illustrative embodiment of scripts that may be utilized to direct caller browsing according to a queue subject in accordance with the method, system, and program of the present invention;

FIG. 5 depicts a high level logic flowchart of a process and program for controlling a PBX system within a call center in accordance with the method, system, and program of the present invention; and

FIG. 6 illustrates a high level logic flowchart of a process and program for controlling an on hold system in accordance with the method, system, and program of the present invention.

### DETAILED DESCRIPTION OF THE PREFERRED EMBODIMENT

A method, system, and program for voice browsing while waiting in a hold queue are provided. Advantageously, voice browsing allows a caller to browse web pages written in a voice extensible markup language (XML) language. In addition, voice browsing preferably provides for browsing web pages in other formats including, but not limited to, HTML, XML, Java and other scripting languages through transcoding the pages into voice XML or an alternate audio format.

For purposes of the present invention, a call center may be accessed via multiple networks including, but not limited to, wireline, wireless, and PSTN networks. In addition, a call center may incorporate multiple elements including, but not limited to, a private exchange switching (PBX) systems, automatic call distribution (ACD) systems, on hold systems, voice browsers, interactive voice response units (IVRU), and other systems which typically control a call center.

In the following description, for the purposes of explanation, numerous specific details are set forth to provide a thorough understanding of the present invention. It will be apparent, however, to one skilled in the art that the present invention may be practiced without these specific details. In other instances, well-known structures and devices are shown in block diagram form to avoid unnecessarily obscuring the present invention.

The present invention may be executed in a variety of systems, including a variety of computing systems and electronic devices under a number of different operating systems. In one embodiment of the present invention, the on hold call queue system is a computer system that incorporates communication features that provide telephony, messaging, and information services to a plurality of callers. In general, the present invention is preferably executed in a computer system that performs computing tasks such as manipulating data in storage that is accessible to the computer system.

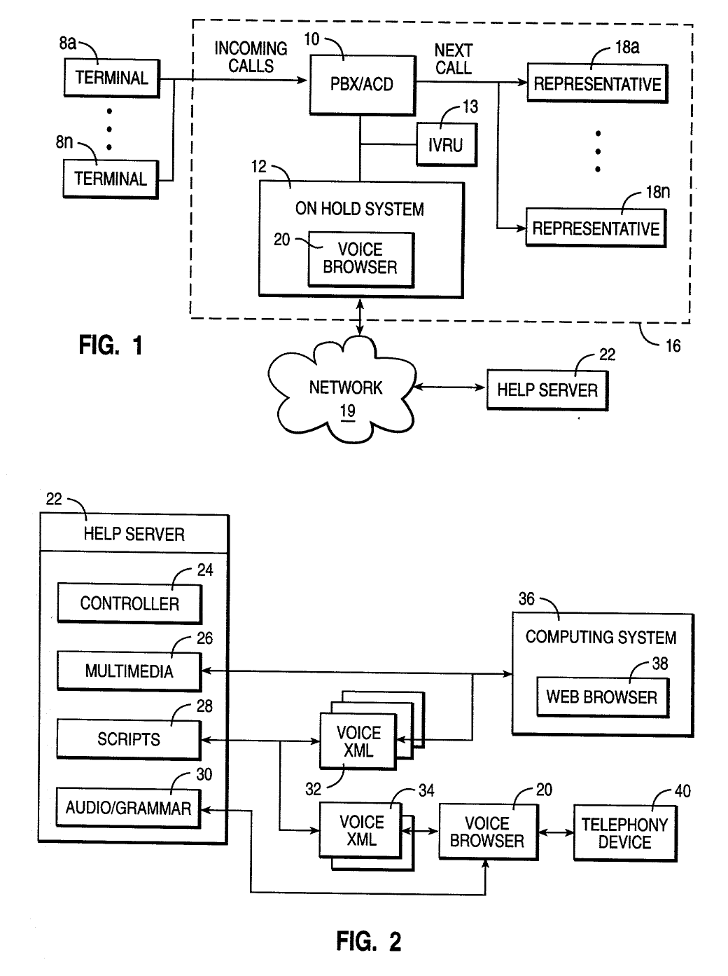

With reference now to the figures, and, in particular, with reference now to FIG. 1, there is an illustrative network call or contact center environment in which the present invention may be implemented. It will be appreciated by one with skill in the art that although a particular network environment is described below, the invention is not limited to use within the described network environment, rather, the inventive queue position advancement process may be implemented within any on-hold information service regardless of the telephony environment.

As illustrated, multiple incoming calls are received at a call center 16. In particular, a private branch exchange switch PBX 10 with automatic call distribution (ACD) ability receives incoming calls via truck 23, where trunk 23 is connected to a network of wireline, wireless, Internet Protocol (IP) networks, and PSTN connections. In particular, PBX systems are well known in the art as switching systems designed to received telephone calls destined for call center 16 and to queue those call when a call handling agent is not available.

PBX 10 distributes incoming calls to multiple representative terminals 18a-18n via trunk 24. In particular, PBX 10 receives incoming calls via trunk 23 from multiple terminals 8a-8n, wherein terminals 8a-8n may represent, but are not limited to, conventional wireline telephone systems, wireless phones, video phones, personal computers, pervasive computing devices configured with appropriate telephony software and Internet connectivity, telephone stations, other PBXs, or switching systems.

In the description which follows, it will be assumed that all representative terminals 18a-18n are busy and therefore PBX 10 cannot respond to an incoming call by making a direct connection to one of representative terminals 18a-18n. As a result, PBX 10 is forced to place the incoming call on hold. In addition, PBX 10 determines the calling telephone number from caller ID or other methods.

After placing the incoming call on hold, the call and caller ID, time of call, and other information obtained by PBX 10 are forwarded to on hold system 12. On hold system 12 preferably creates a record based on the call and positions the call within a call queue. While in the present embodiment PBX 10 forwards calls to a single on hold system, in alternate embodiments, PBX 10 may forward calls to multiple on hold systems. In addition, on hold system 12 and other on hold systems may be coupled to PBX 10 or may be remotely accessed by PBX 10. Further, while in the present embodiment on hold system 12 is depicted as an independent system, on hold system 12 may also be incorporated within PBX 10.

While the call is on hold, an interactive voice response unit (IVRU) 13, coupled to PBX 10 and on hold system 12, may offer the caller a menu of available options for receiving call hold queue information for on hold system 12. In general, IVRU 13 is a voice information system which may be arranged to (i) prompt a caller for specific information by asking questions based on a set of modules in a transactions script, (ii) collect that information by detecting and interpreting dual tone multifrequency (DTMF) signals entered by the caller or by recognized speech input by the caller, (iii) organize the collected information in a specific format and (iv) forward the collected information to be utilized within on hold system 12. For purposes of the present invention, prompts to the caller may be in voice, text, video, and/or graphical formats depending on the interface receiving the prompt. Alternatively, a voice browser may be implemented in lieu of IVRU 13, where voice XML pages provide the script for the menu of available options.

According to one advantage of the present invention, a voice browser 20 is also implemented within on hold system 12. Voice browser 20 is utilized for browsing the Internet and in particular for browsing pages stored at help server 22.

Help server 22 preferably includes web scripts that may be output to multiple devices including computer systems via a web browser and telephony devices via a voice browser. In particular, the scripts may include help information that is searchable by a user through a web browser, but is also searchable by a caller via a voice browser.

For an IVRU to play the help information to a caller, the information would need to be stored in a script that is readable by the IVRU. In addition, redundant copies of the same information would be stored in multiple places including the web server and the IVRU. However, according to the present invention, browsable scripts only need be stored in one location to service callers and web surfers.

With reference now to FIG. 2, there is an illustrative block diagram of a voice browsing system in accordance with the method, system, and program of the present invention. For purposes of the present invention, help server 22 is a web based server communicatively connected to network 19. As depicted, help server 22 includes a controller 24 for controlling the operations of help server 22. In particular controller 24 may include at least one processor, memory, data storage, system software, and application software.

In addition, help server 22 includes multimedia database 26 and audio/grammar database 30. Multimedia database 26 may include graphics, sound, video and other data that may be read by a web browser 38 executing on computing system 36. Help server 22 also includes audio/grammar database 30 for directing voice browser 20 in converting voice XML into audio output.

Further, help server 22 includes scripts 28. Scripts 28 includes programmed web pages that may be output as HTML documents 32 or voice XML documents 34. HTML documents 32 are preferably transmitted to a computing system for output via a display interface controlled by web browser 38. Voice XML documents are preferably converted into audio output by voice browser 20 and output via a telephony device 40. Telephony device 40 may include a wireline phone, a wireless phone, a PDA with telephony features, and other computing devices with telephony features that provide audio input and output.

In the present invention, scripts 38 preferably include information including, but not limited to, directions, frequently asked questions, product and service specifications, product and service advertising, and other information which may be visibly and audibly output. Scripts 38 are preferably designed in a hierarchy according to subject, such that a user or caller may easily transition from one page to the next within a particular subject. Further, scripts 38 allow for a user of computing system 36 or a caller from telephony device 40 to receive the same help information.

In addition, in the present invention, voice browser 20 includes audio output (computer-synthesized and/or recorded) and audio input (voice and/or keypad tones). Importantly, voice browser 20 connects the Internet with a phone network in order to extend the power of the web to telephony devices while a call placed via those telephony devices is waiting on hold.

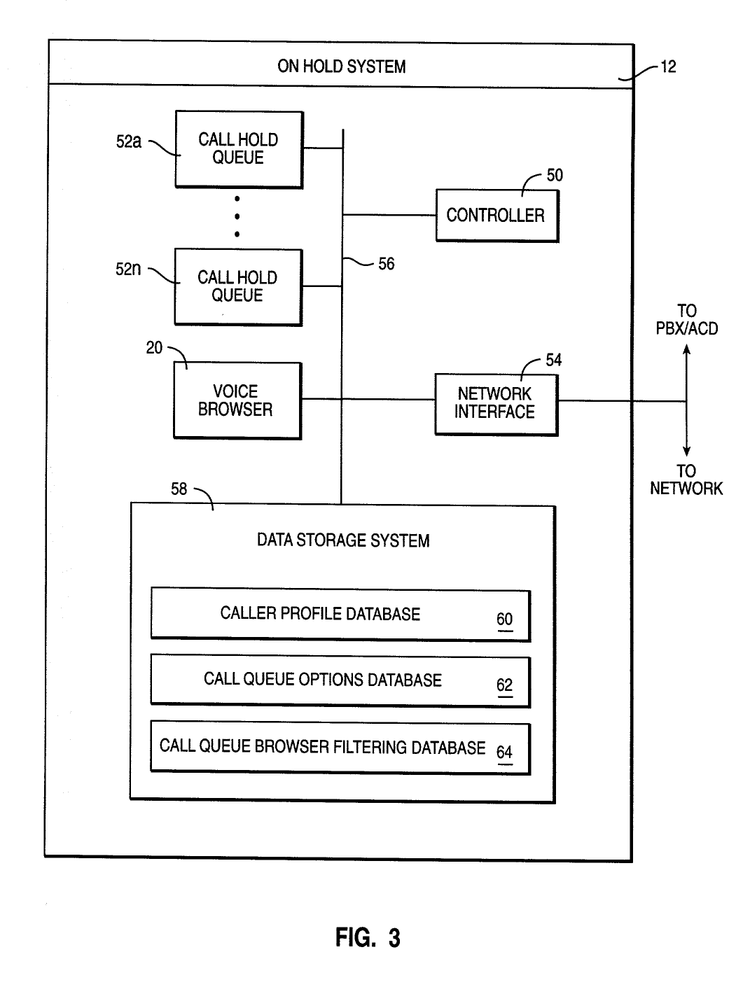

Referring now to FIG. 3, there is an illustrative block diagram of an on hold system in accordance with the method, system, and program of the present invention. As illustrated, on hold system 12 includes a controller 50, call hold queues 52a-52n, a network interface 54, voice browser 20, and a data storage system 58 communicatively connected via a bus 56. Additional systems may be connected along bus 56 that are not depicted herein. In particular, controller 50 comprises conventional computer resources including, but are not limited to, at least one processor, memory, a data storage system, system software and application software, that function together to perform the functions described with reference to controller 50.

Network interface 54 preferably communicates with PBX 10 via a telephone network and network 19 via a network connection such as a wide area network (WAN) connection. In particular, network interface 54 receives transfers of calls from PBX 10 and then returns calls to PBX 10 when a call is the next in line within one of call hold queues 52a-52n.

In the present invention, voice browser 20 preferably controls audio output and detects audio inputs of voice and/or keypad tones. In particular, voice XML documents for controlling initial menu options to a caller may be stored in call queue options database 62. Alternatively, such voice XML documents may be stored remotely, such as at help server 22, and accessed via network 19.

For example, when a call is first received at on hold system 12, a first voice XML scripted document may be utilized to prompt and direct the placement of a call within one of call hold queues 52a-52n. In particular, a caller may be given the option of selecting between multiple subject matters or skills, where each of call hold queues 52a-52n is specified according to a subject matter or skill. When calls are next in line to be transferred to a representative, the subject matter or skill of the queue determines which representatives may receive the call.

Then, depending on the call hold queue, multiple service options are presented to the caller according to a voice XML scripted document controlled by voice browser 20. Service options may include, but are not limited to, browsing web pages specified for the queue, browsing the web in general, listening to music, news or weather, making a third-party call, and other activities.

According to an advantage of the present invention, the subject and service options are first filtered according to the caller profile associated with the caller ID of the call, such that the caller is only presented with those options that are specifically designated by the caller and those options which are tailored to the caller according to the caller profile. Caller profiles may be stored in caller profile database 60 and/or accessed from a remote caller profile server via network 19, as described in U.S. patent application Ser. No. ______ (Attorney Docket No. AUS920010944US1).

In addition, to filtering subject and service options to only present preferred types of options, any output directed by voice browser 20 to a caller may be specified by a caller's profile. In particular, the language, dialect, speed, volume and other characteristics of output to a caller may be specified by the caller's profile.

In the present invention, where a caller selects to browse the web according to the subject matter of a particular queue, the caller is then provided with topics of web pages that are associated with the particular queue. In particular, it is advantageous to direct the caller to particular web pages, such that the caller does not have to manually through a hierarchy of web pages in order to find information relevant to a caller's question or problem.

Call queue browser filtering database 64 preferably includes a database of web pages specified according to topic and voice XML scripts for directing a caller to select from the database of web pages. For example, if a caller selects to receive help with a printer issue, then the caller is placed in a printer related call queue. A hierarchy of available web pages relating to printer issues is included in call queue browser filtering database 64 with prompts for a caller that will direct the caller to one of the available web pages relating to printer issues.

In addition, the caller may select to browse the web in general where the caller may then input via voice or keypad a web address to begin browsing. Where a caller selects to listen to music, news or weather, the caller may further indicate a web site that is a preferred source for this information. In particular, a menu of typical web sites preferred by callers may be provided such that the caller does not have to enter a specific web address.

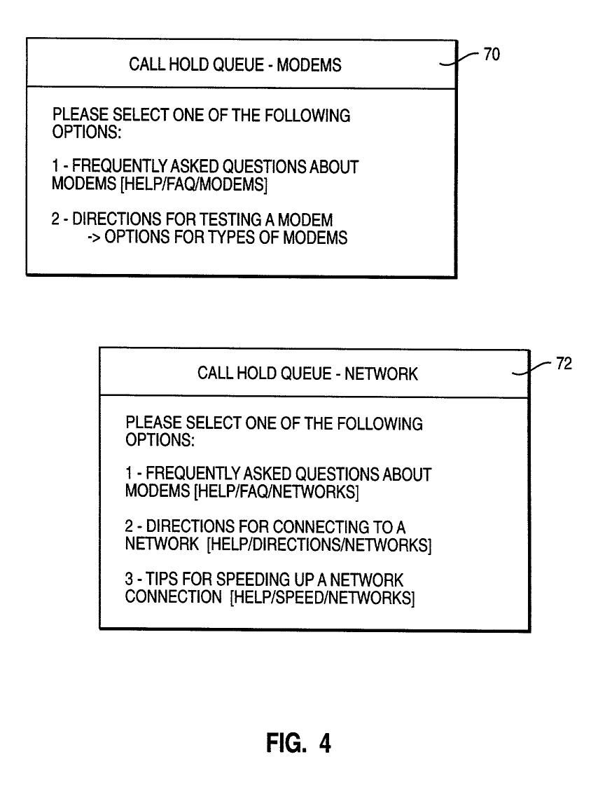

With reference now to FIG. 4, there is an illustrative embodiment of scripts that may be utilized to direct caller browsing according to a queue subject in accordance with the method, system, and program of the present invention. As depicted, scripts 70 and 72 are voice XML scripted documents specified according to the call hold queue that a caller is positioned within.

Script 70 details audio output and associated input for a call hold queue for help with modems while script 72 details audio output and associated input for a call hold queue associated with networks.

Preferably the caller is asked to select from among options with designated voice or keypad inputs. For example, if a caller in the modem call hold queue inputs a “1” the voice browser will begin to browse a web page script for frequently asked questions about modems.

The voice XML script requested by a voice browser in response to a caller input is indicated in brackets. Therefore, in the previous example, where the caller in the modem call hold queue inputs a “1”, the voice browser will request a voice XML document stored in a web page hierarchy at “help/faq/modems”. Alternative types of addressing may be utilized for requesting pages.

Scripts, such as script 70 or script 72, may include multiple levels of options. For example, if a caller in the model call hold queue inputs a “1”, the voice browser will move to the next level of options in the script that asks the caller to select from multiple options that specify the type of modem. By providing multiple levels of options, the script may prompt the caller to narrow the caller's question to the most relevant information and then retrieve a voice XML script for the web page with the most relevant information.

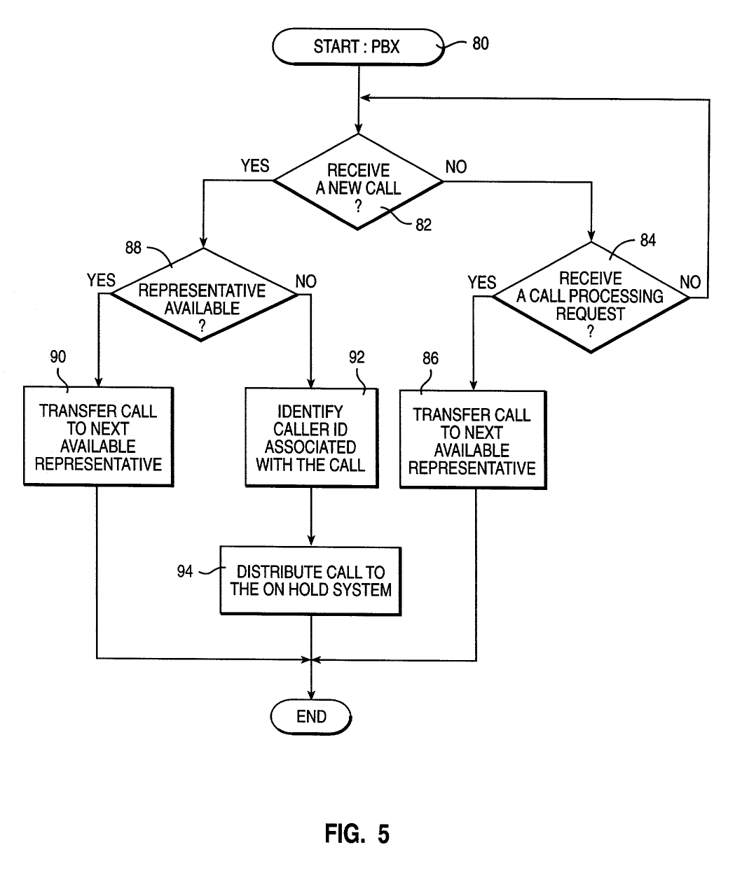

Referring now to FIG. 5, there is depicted a high level logic flowchart of a process and program for controlling a PBX system within a call center in accordance with the method, system, and program of the present invention. As illustrated, the process starts at block 80 and thereafter proceeds to block 82.

Block 82 depicts a determination as to whether a new call is received. If a new call is received, then the process passes to block 88. If a new call is not received, then the process passes to block 84. Block 84 illustrates a determination as to whether or not a call processing request is received. When a call is at the top of the call queue, the call is preferably transferred back to the PBX with a call processing request. If a call processing request is not received, then the process passes to block 82. If a call process request is received, then the call is transferred to the next available representative, as depicted at block 84, and the process ends.

Block 88 illustrates a determination as to whether or not a representative is available. If a representative is available, then the call is transferred to the next available representative, as illustrated at block 90, and the process ends. If a representative is not available, then the process passes to block 92. Block 92 depicts identifying the caller ID associated with the call. Next, block 94 illustrates distributing the call to the on hold system, and the process ends.

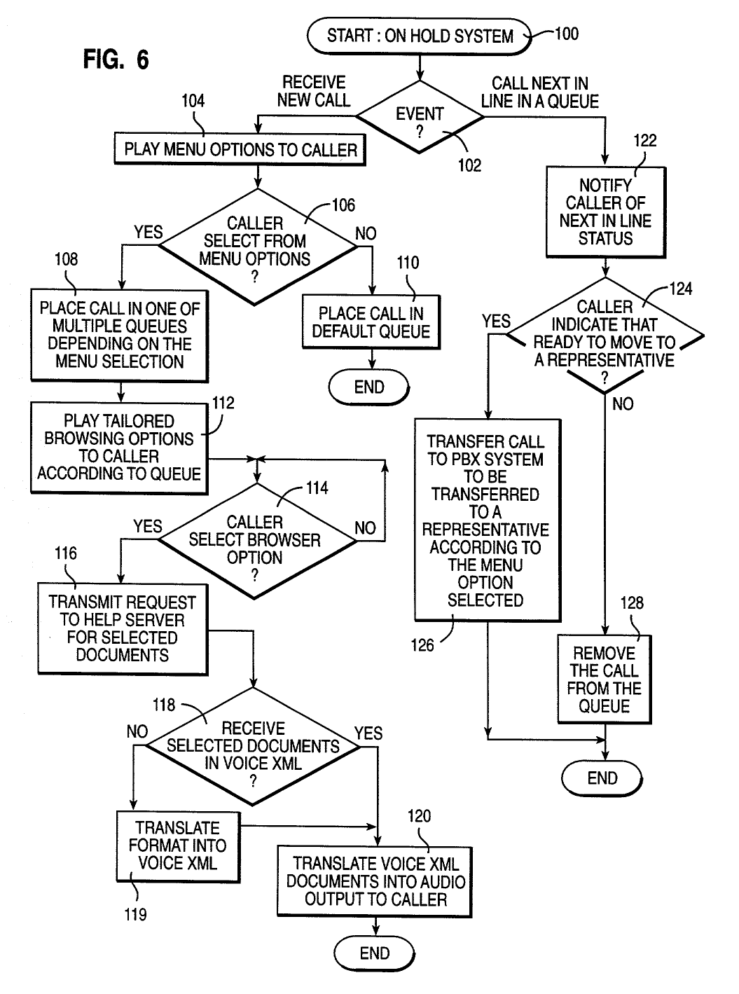

With reference now to FIG. 6, there is depicted a high level logic flowchart of a process and program for controlling an on hold system in accordance with the method, system, and program of the present invention. As illustrated, the process starts at block 100 and thereafter proceeds to block 102.

Block 102 depicts a determination as to what event occurred when an event occurs. If a new call is received, then the process passes to block 104. If a call is detected as being the next in line in a queue, then the process passes to block 122.

Block 104 illustrates playing a menu of queue options to a caller. As previously described, the menu of queue options and other output to a caller may be specified according to a caller profile detected according to caller ID.

Next, block 106 illustrates a determination as to whether a caller has selected from the menu options. If a caller does not select from the menu options, then the call is placed in a default queue, as illustrated at block 110, and the process ends. If a caller does select from the menu options, then the process passes to block 108.

Block 108 depicts placing the call in one of the multiple queues depending on the menu selection. Next, block 112 illustrates playing tailored browsing options to the caller according to the queue. In addition other service options may be presented to the caller. Further, where there is only one queue, rather than multiple queues, browsing options may be offered for callers in the one queue.

Block 114 depicts a determination as to whether the caller selects a browser option. The process may iterate at block 114 for a period of time if no browser option is selected. When a browser option is selected, then the process passes to block 116.

Block 116 illustrates transmitting a request for a documents of particular browser selection to the help server. Next, block 118 depicts a determination as to whether the selected documents are received in voice XML. If the selected documents are received in voice XML, then the voice XML documents are translated by the voice browser into audio output to the caller, as depicted at block 120, and the process ends. If the selected documents are not received in voice XML, then translation and transcoding of the documents into the voice XML format is performed, as illustrated at block 119, before the process passes to block 120.

In response to the call being next in line in a queue, the caller is notified of the next in line status, as illustrated at block 122. Next, block 124 depicts a determination as to whether the caller indicates a readiness to transfer to a representative. According to the advantage of the present invention, the caller may access needed information by voice browsing and no longer needs the assistance of a representative. If the caller does not indicate a readiness to transfer to a representative, then the call is removed from the queue, as illustrated at block 128, and the process ends. If a caller does indicate a readiness to transfer to a representative, then the process passes to block 126. Block 126 depicts transferring the call to the PBX system to be transferred to a representative according to the menu option (or queue subject) selected by a caller, and the process ends.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

While the invention has been particularly shown and described with reference to a preferred embodiment, it will be understood by those skilled in the art that various changes in form and detail may be made therein without departing from the spirit and scope of the invention.

What is claimed is:

1. A method for managing voice browsing while a call is on hold comprising:
receiving a call from a particular caller at an on hold system;
responsive to a selection of a help subject by said particular caller, prompting said particular caller with a menu of browsable help information specified for said help subject; and
responsive to a selection from among said menu of browsable help information, translating a web script for said selection from among said menu of browsable help information into audio output to said particular caller.

2. The method for managing voice browsing according to claim 1, further comprising:
prompting said particular caller to select said help subject from among a plurality of help subjects;
placing said call in a particular hold queue from among a plurality of hold queues, where said particular hold queue is related to said help subject.

3. The method for managing voice browsing according to claim 1, further comprising:
prompting said particular caller when said call is next in line to be answered by a representative;
responsive to said particular caller indicating a readiness to move to said representative, transferring said call to a PBX system for distribution to said representative; and
responsive to said particular caller not indicating a readiness to move to said representative, removing said call from a hold queue.

4. The method for managing voice browsing according to claim 1, further comprising:
transferring a request to a help server via a network for said web script associated with said selection from among said menu of browsable help information.

5. The method for managing voice browsing according to claim 1,
wherein translating said web script further comprises:
translating a voice XML script comprising selected help information into audio output to said particular caller.

6. The method for managing voice browsing according to claim 1, wherein translating said web script further comprises:
transcoding said web script into voice XML script; and
translating said voice XML script into audio output to said particular caller.

7. The method for managing voice browsing according to claim 1, wherein said web script is received from a help server in a first format controllable by a voice browser, wherein said help server is enabled to transfer said web script in a second format controllable by a web browser at a computer system.

8. A system for managing voice browsing while a call is on hold comprising:
an on hold system for holding a call from a particular caller;
means responsive to a selection of a help subject by said particular caller, for prompting said particular caller with a menu of browsable help information specified for said help subject; and
means responsive to a selection from among said menu of browsable help information, for translating a web script for said selection from among said menu of browsable help information into audio output to said particular caller.

9. The system for managing voice browsing according to claim 8, further comprising:
means for prompting said particular caller to select said help subject from among a plurality of help subjects;
means for placing said call in a particular hold queue from among a plurality of hold queues, where said particular hold queue is related to said help subject.

10. The system for managing voice browsing according to claim 8, further comprising:
means for prompting said particular caller when said call is next in line to be answered by a representative;
means responsive to said particular caller indicating a readiness to move to said representative, for transferring said call to a PBX system for distribution to said representative; and
means responsive to said particular caller not indicating a readiness to move to said representative, for removing said call from a hold queue.

11. The system for managing voice browsing according to claim 8, further comprising:
means for transferring a request to a help server via a network for said web script associated with said selection from among said menu of browsable help information.

12. The system for managing voice browsing according to claim 8,
wherein said means for translating said web script further comprises:
means for translating a voice XML script comprising selected help information into audio output to said particular caller.

13. The system for managing voice browsing according to claim 8, wherein said means for translating said web script further comprises:
means for transcoding said web script into voice XML script; and
means for translating said voice XML script into audio output to said particular caller.

14. The system for managing voice browsing according to claim 8, wherein said web script is received from a help server in a first format controllable by a voice browser, wherein said help server is also enabled to transfer said web script in a second format controllable by a web browser at a computer system.

15. A computer program product for managing voice browsing while a call is on hold, said computer program product comprising:
a recording medium;
means, recorded on said recording medium, for managing a call from a particular caller on hold;
means, recorded on said recording medium, for prompting said particular caller with a menu of browsable help information specified for a help subject select by said particular caller; and
means, recorded on said recording medium, for translating a web script for a selection by said particular caller from among said menu of browsable help information into audio output to said particular caller.

16. The computer program product for managing voice browsing according to claim 15, further comprising:
means, recorded on said recording medium, for prompting said particular caller to select said help subject from among a plurality of help subjects;
means, recorded on said recording medium, for placing said call in a particular hold queue from among a plurality of hold queues, where said particular hold queue is related to said help subject.

17. The computer program product for managing voice browsing according to claim 15, further comprising:
means, recorded on said recording medium, for enabling transfer of a request to a help server via a network for said web script associated with said selection from among said menu of browsable help information.

18. The computer program product for managing voice browsing according to claim 15, wherein said means for translating said web script further comprises:
means, recorded on said recording medium, for translating a voice XML script comprising selected help information into audio output to said particular caller.

19. The computer program product for managing voice browsing according to claim 15, wherein said means for translating said web script further comprises:
means, recorded on said recording medium, for transcoding said web script into voice XML script; and
means, recorded on said recording medium, for translating said voice XML script into audio output to said caller.

20. A method for managing general voice browsing for a call on hold comprising:
receiving a call from a particular caller at an on hold system;
responsive to receiving a web page selection from said particular caller via a telephony device, requesting said web page selection from a server system via a network; and
responsive to receiving a web script for said web page selection, translating said web script into audio output to said caller.

21. The method for managing general voice browsing according to claim 8, further comprising:
receiving a voice XML script for said web page selection; and
translating said web script through a voice browser into said audio output.
